(19) United States
(12) Patent Application Publication
(10) Pub. No.: US 2007/0222901 A1
(43) Pub. Date: Sep. 27, 2007

(54) Television receiving apparatus

(75) Inventors: Hirono Tsubota, Osaka (JP); Yasunari Miyake, Osaka (JP); Masahiro Takeshita, Osaka (JP); Hideki Tanabe, Osaka (JP); Yasuo Masaki, Osaka (JP); Yukiyoshi Sasao, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/726,723

(22) Filed: Mar. 22, 2007

(30) Foreign Application Priority Data
Mar. 22, 2006 (JP) 2006-079145

(51) Int. Cl. H04N 5/44; G08C 19/00; H04B 10/00

(52) U.S. Cl. 348/734; 340/825.72; 398/106

(57) ABSTRACT

A television capable of reporting a history of operation by an operator of an appliance is provided. The television is connected to an antenna. The television has main components including an external input unit, a light receiving unit, a user's operation unit, a CPU controlling operation of the television, a tuner, a switch circuit, and a communication IF capable of communicating information via the Internet. The CPU generates information about a user's operation history based on a control signal for an appliance that is received by the light receiving unit, and transmits the information to another information communication apparatus via the communication IF.

### BACKGROUND OF THE INVENTION

1. Field of the Invention

The present invention relates to a television receiving apparatus, particularly to a television receiving apparatus having monitoring capability.

2. Description of the Background Art

As the variety of living environment increases, some people wish to know the conditions of their family member living in a remote place. Accordingly, techniques have been disclosed according to which, for example, a signal indicative of user's operation of such a household electrical appliance as television is transmitted in order to report the state of the user's operation of the appliance.

For example, Japanese Patent Laying-Open No. 2004-274296 discloses an information processing system for confirming whether a person is safe and well that is less troublesome for solitary elderly people to use and that is easy to install.

Japanese Patent Laying-Open No. 09-028681 discloses a safety confirmation system that can give notice only in the case where an abnormality actually occurs.

Japanese Patent Laying-Open No. 2001-291176 discloses an abnormality monitoring apparatus that can immediately detect an abnormality in behavior of a cared person without requiring constant monitoring by a caring person.

Japanese Patent Laying-Open No. 2000-293774 discloses a safety confirmation apparatus with which whether a solitary elderly person is safe and well can be confirmed readily and surely.

Japanese Patent Laying-Open No. 2002-373210 discloses a life activity evaluation system that can spontaneously accumulate the activity of daily living of such a subject as elderly person while ensuring privacy and can evaluate the activity of living.

### SUMMARY OF THE INVENTION

The techniques disclosed in respective publications, however, require a separate device for receiving a remote control signal, in addition to such a household electrical appliance as television. Moreover, if the device does not operate normally, information about the operator may not be transmitted correctly.

The present invention has been made to solve the above-described problems. An object of the invention is to provide a television receiving apparatus that can watch in simple manner the state of a user of an appliance that is controllable with a remote control.

In order to achieve the object, a television receiving apparatus according to an embodiment of the present invention includes a display unit displaying an image and a light receiving unit receiving an infrared signal for controlling operation of a plurality of appliances each. The infrared signal includes appliance data for identifying the appliances each and control data for instructing to change a predetermined operation of the appliances each. The television receiving apparatus further includes a storage unit storing the control data, a control unit controlling, when the appliance data is data for identifying the television receiving apparatus, operation of the television receiving apparatus based on the control data, and a generation unit generating, based on the data for instructing to change the operation, data showing that the operation is changed, as user's operation data. The storage unit further stores identification data for identifying a communication apparatus that is a destination of the user's operation data. The television receiving apparatus further includes a transmission unit transmitting the user's operation data through a communication line based on the identification data.

A television receiving apparatus according to another embodiment of the present invention includes a display unit displaying an image and a light receiving unit receiving an infrared signal used for controlling operation of a plurality of appliances each. The infrared signal includes appliance data for identifying the appliances each and data for instructing to perform a predetermined operation of the appliances each. The television receiving apparatus further includes a storage unit storing the control data, a control unit controlling, if the appliance data is data for identifying the television receiving apparatus, operation of the television receiving apparatus based on the control data, a generation unit generating, based on the control data associated with the appliance data, user's operation data showing details of operation of the appliance identified by the appliance data, and an output unit outputting the user's operation data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a network to which a television 100 is connected according to an embodiment of the present invention.

FIG. 2 is a block diagram showing a hardware configuration of television 100.

FIG. 3 is a block diagram showing a configuration of functions implemented by a CPU 210.

FIG. 4 conceptually shows a manner of storage of data in a memory 252.

FIG. 5 is a block diagram showing a hardware configuration of a remote control 130.

FIG. 6 conceptually shows a structure of a packet 600 transmitted from a mobile phone 180 to television 100.

FIG. 7 conceptually shows a structure of a packet 700 transmitted from television 100 to mobile phone 180.

FIG. 8 is a flowchart showing a process procedure performed when television 100 receives an infrared signal transmitted from remote control 130.

FIG. 9 is a flowchart showing a process procedure performed by television 100 for transmitting data stored in memory 252.

FIG. 10 conceptually shows a manner of storage of data in memory 252.

FIG. 11 shows a configuration of remote control 130 capable of transmitting data for identifying a remote control operator.

FIG. 12 shows a structure of an infrared signal 1200 transmitted by remote control 130.

FIG. 13 is a flowchart showing a process procedure performed when television 100 receives an infrared signal from remote control 130.

FIG. 14 is a flowchart showing a process procedure performed by television 100 for transmitting a user's operation history to a specific user.

FIG. 15 shows a network configuration in which a television 1500 is used according to a third embodiment of the present invention.

FIG. 16 is a block diagram showing a hardware configuration of a computer system serving as an appliance information management server 1510.

FIG. 17 conceptually shows a manner of storage of data on a hard disk 1650.

FIG. 18 conceptually shows a structure of a packet 1800 transmitted from television 1500 to appliance information management server 1510.

FIG. 19 conceptually shows a structure of a packet 1900 transmitted from appliance information management server 1510 to television 1500.

FIG. 20 is a flowchart showing a process procedure performed by a CPU 1610 of appliance information management server 1510.

FIG. 21 is a flowchart showing a process procedure performed when television 1500 receives an infrared signal from remote control 130.

FIG. 22 is a flowchart showing a process procedure implemented when a user makes a predetermined connection for obtaining appliance information.

FIG. 23 shows television 1500 displaying appliance information.

### DESCRIPTION OF THE PREFERRED EMBODIMENTS

With reference to the drawings, embodiments of the present invention are hereinafter described. In the following description, like components are denoted by like reference characters. They are named identically and also function identically. Therefore, a detailed description thereof is not repeated.

### First Embodiment

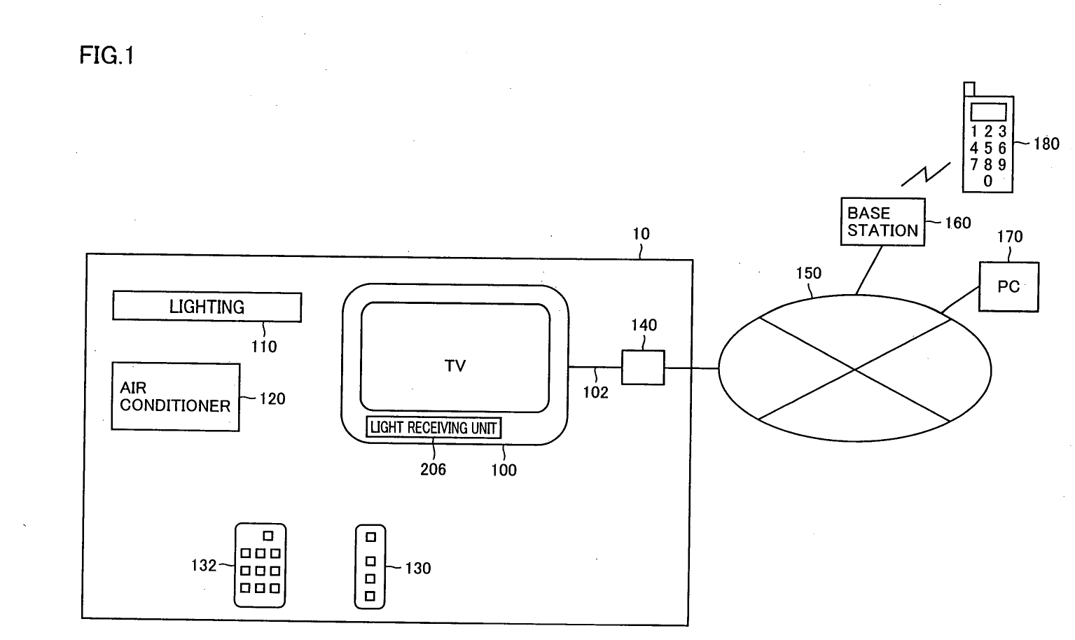

Referring to FIG. 1, a television 100 is described according to a first embodiment of the present invention. Television 100 may be any of those including liquid crystal television, plasma television, CRT television and televisions of other types.

Television 100 is installed in a house 10. In house 10, a lighting 110 and an air conditioner 120 are further installed. Television 100 is connected to a gateway 140 via a wired or wireless communication channel 102. Gateway 140 is connected to the Internet 150. Television 100 is, controlled for example by a remote control 130. Television 100 includes a light receiving unit 206 for receiving an infrared signal transmitted from remote control 130. Lighting 110 and air conditioner 120 are controlled by a remote control 132 that can control a plurality of appliances. Remote control 132 may be configured to control the operation of television 100 in addition to that of lighting 110 and air conditioner 120.

To the Internet 150, a base station 160 and a PC (Personal Computer) 170 are connected. Base station 160 communicates with a mobile phone 180. The manner of communication between the television and the Internet 150 is not limited to a particular one. The communication is not limited to the one via a public network and may be such communication as digital communication used for communication for mobile phones.

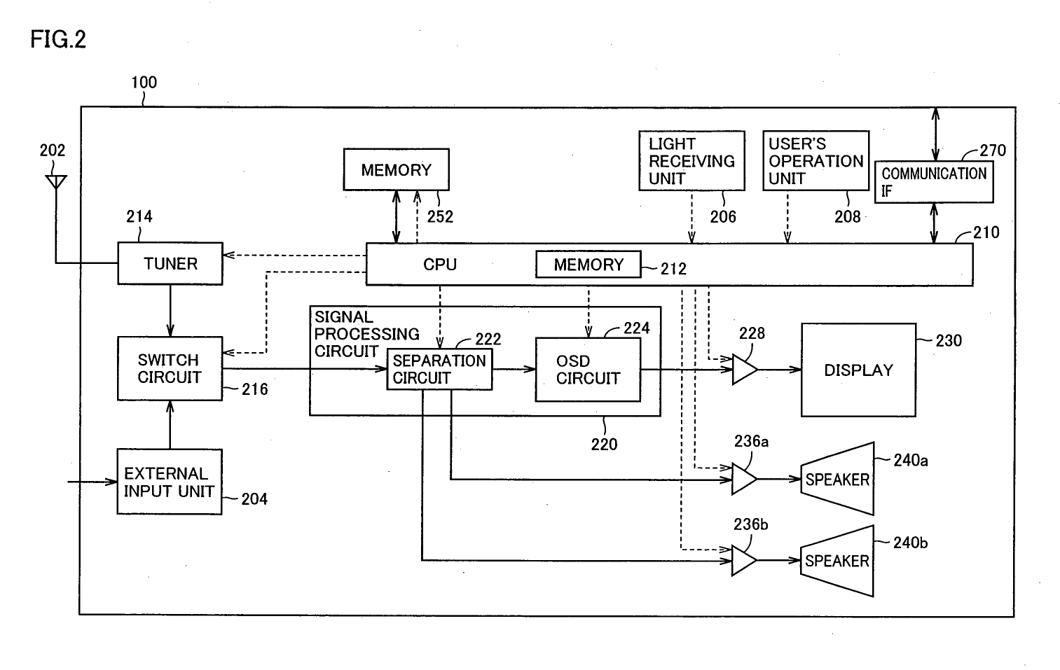

Referring to FIG. 2, a hardware configuration of television 100 is described. Television 100 is connected to an antenna 202. Television 100 includes, as main components, an external input unit 204, light receiving unit 206, a user's operation unit 208, a CPU (Central Processing Unit) 210 controlling the operation of television 100, a tuner 214, and a switch circuit 216. CPU 210 includes a memory 212 and a clock (not shown).

A broadcast signal received by antenna 202 is transmitted to tuner 214. Tuner 214 selects a channel to which the television is to be tuned as instructed based on a control signal output from CPU 210. External input unit 204 accepts input of video and audio signals that are externally supplied. For example, external input unit 204 accepts input of video and audio signals that are transmitted from a VTR (Video Tape Recorder), a DVD (Digital Versatile Disc) player and other video reproduction apparatuses. The video and audio signals are transmitted from external input unit 204 to switch circuit 216. External input unit 216 may separately accept input of a video signal and input of an audio signal or accept input of each signal together.

Switch circuit 216 selectively outputs one of a signal output from tuner 214 and a signal output from external input unit 204 based on a switch command output from CPU 210.

Television 100 further includes a memory 252 and a communication IF (Interface) 270. Memory 252 is, for example, flash memory. The memory stores a history of user's operations performed on television 100 that is output from CPU 210. A data structure in memory 252 is hereinlater described. Communication IF 270 is connected to cable 102 used for network communication. Communication IF 270 communicates with other information communication apparatuses. These other information communication apparatuses include for example mobile phone 180 and PC 170 as shown in FIG. 1.

Referring again to FIG. 2, television 100 includes a signal processing circuit 220, a driver 228, a display 230, amplifiers 236a, 236b, and speakers 240a, 240b. Signal processing circuit 220 includes a separation circuit 222 and an OSD (On Screen Display) circuit 224.

The signal output from switch circuit 216 is input to separation circuit 222. Separation circuit 222 separates a video signal and an audio signal from each other based on a command from CPU 210. The video signal output from separation circuit 222 is input to OSD circuit 224. The audio signal output from separation circuit 222 is transmitted to amplifiers 236a, 236b each.

OSD circuit 224 generates a signal for displaying an image on display 230 based on a command from CPU 210. The image includes such character information as the channel number for example and other information items. The character information also includes indication of a volume level and indication of operation of television 100. The indication of operation includes, for example, increase or decrease of the volume and change of the contrast. More specifically, OSD circuit 224 synthesizes the video signal output from separation circuit 222 and an image signal generated based on data stored in advance in memory 212 to output the signal generated by the synthesis to driver 228.

Driver 228 displays an image on display 230 based on the signal output from OSD circuit 224. Amplifiers 236a, 236b amplify each audio signal output from separation circuit 222 to output amplified signals to speakers 240a, 240b respectively. Speakers 240a, 240b output sounds based on the signals.

Preferably, in the case where an appliance code that is included in a received signal and that is used for identifying an appliance is data representing television 100, CPU 210 controls operation of television 100 based on the control data. Further, based on control data associated with an appliance code for identifying another appliance, CPU 210 generates user's operation data representing details of operation of that another appliance (remotely controllable electrical appliances such as air conditioner and lighting) identified by the appliance code.

Preferably, the control data includes data for giving an instruction to change operation of each appliance. Based on the data for giving the instruction to change the operation, CPU 210 generates, as the user's operation data, data showing that the operation has been changed.

More specifically, in the case where the aforementioned another appliance is the air conditioner, the data for instructing to change operation may include data giving an instruction to power on or off the air conditioner. Based on the data for instructing to power on or off the air conditioner, CPU 210 generates data as the user's operation data showing that the operation of the air conditioner has been changed.

In another aspect, the appliance may be the lighting. In this case, the data for instructing to change operation is data for instructing to turn on or off the lighting. Based on the data for instructing to turn on or off the lighting, CPU 210 generates data, as the user's operation data, showing that the lighting has been turned on or off.

In still another aspect, CPU 210 controls communication IF 270 so that the user's operation data is transmitted at predetermined time intervals based on the time from the built-in clock. Specifically, connection to the Internet 150 is started.

In a further aspect, CPU 210 controls communication IF 270 so that the user's operation data is transmitted at a predetermined time based on the time from the internal clock.

Preferably, in the case where reception of a signal including an instruction to request transmission of the user's operation data is detected, CPU 210 generates the user's operation data based on the instruction to instruct communication IF 270 to transmit the user's operation data.

Preferably, the control data is successively stored. In this case, based on a request to transmit history information, CPU 210 uses control data that is stored lastly at the time when the request is received, to generate the user's operation data.

In a further aspect, television 100 may have the capability of transmitting such a control signal as infrared signal for example (the television may have for example an infrared transmission unit). In this case, CPU 210 receives via communication IF 270 a command including an instruction to transmit the control signal for controlling any appliance. Based on the command, CPU 210 instructs the infrared transmission unit to transmit the control signal. Accordingly, the appliance operates based on the signal from television 100. For example, based on an infrared signal from television 100, air conditioner 120 is powered on.

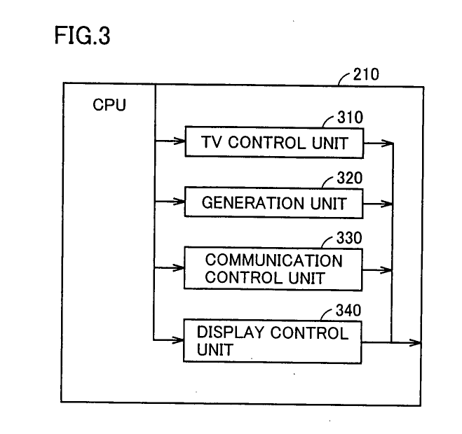

Referring to FIG. 3, CPU 210 of television 100 is described. CPU 210 includes a television control unit 310, a generation unit 320, a communication control unit 330 and a display control unit 340.

Television control unit 310 performs a process for implementing operation of television 100, based on an infrared signal received via light receiving unit 206 or based on user's operation that is input to user's operation unit 208.

Generation unit 320 generates, based on data stored in memory 252 or memory 212, a signal for reporting the state of user's operation of the remote control that is detected by television 100. The remote control may be for example remote control 130 dedicated to the television or remote control 132 for controlling other appliances as shown in FIG. 1. Specifically, generation unit 320 generates packet data for transmitting to the Internet 150 a history of user's operation stored in memory 252.

Communication control unit 330 controls communication, that is made via communication IF 270 with other information communication apparatuses. Communication control unit 330 starts the communication based on an instruction to communicate given as communication with the outside of television 100 is detected via light receiving unit 206 or user's operation unit 208 or based on report of the time set in advance by the internal clock (not shown) of CPU 210.

Display control unit 340 performs a process for instructing display 230 to display an image based on data received via communication IF 270. For example, display control unit 340 instructs display 230 to display a text included in an electronic mail received from mobile phone 180 or PC 170.

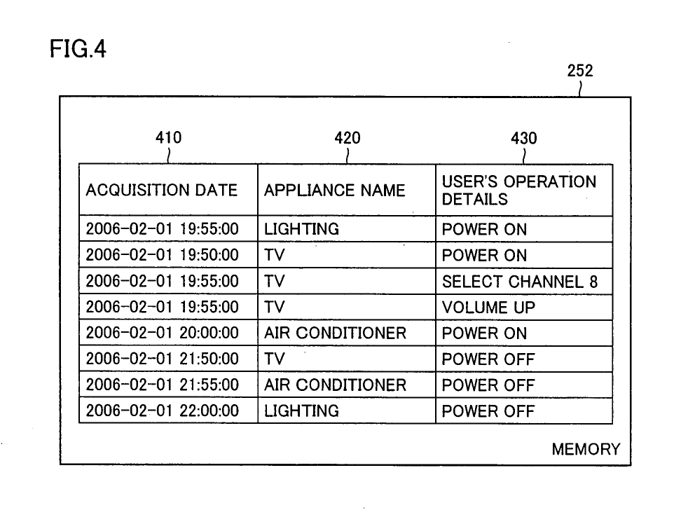

Referring to FIG. 4, a data structure of television 100 is described. FIG. 4 conceptually shows a manner of storage of data in memory 252. Memory 252 includes areas 410 to 430 for storing data.

Data showing the date at which a control signal is obtained is stored in area 410. This data is generated based on time data of the clock that is stored in memory 212. Data representing the name of an appliance is stored in area 420. This data is obtained from a code for identifying an appliance. The code is included in an infrared signal received by light receiving unit 206. Data representing details of user's operation performed on the remote control is stored in area 430. This data corresponds to control data included in the infrared signal received by light receiving unit 206. Data stored in areas 410 to 430 are associated with each other. Therefore, by selecting any date at which the control signal is obtained, details of the user's operation performed at the time as well as the device on which the operation is performed are identified by the data stored in areas 430 and 420 respectively.

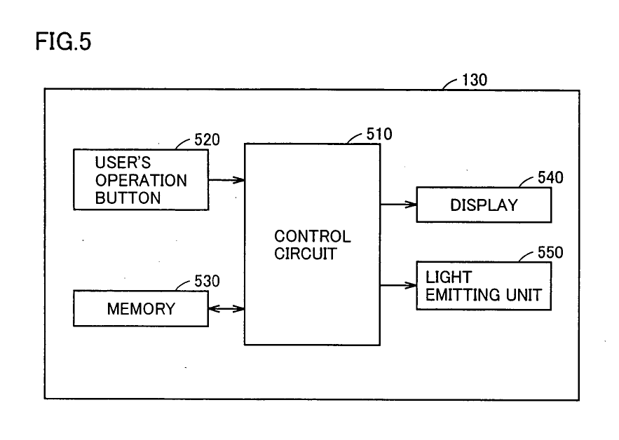

Referring to FIG. 5, remote control 130 is described. FIG. 5 is a block diagram showing a hardware configuration of remote control 130. Remote control 130 includes a control circuit 510, a user's operation button 520, a memory 530, a display 540 and a light-emitting unit 550.

Control circuit 510 is supplied with electric power from a battery (not shown) to control operation of remote control 130. Specifically, based on a signal corresponding to user's operation accepted by user's operation button 520, a control signal is generated and transmitted as an infrared signal from light-emitting unit 550.

Further, based on user's operation that is input to user's operation button 520, control circuit 510 generates character information corresponding to the user's operation and instruct display 540 to display the character information. Memory 530 stores in advance data for such display.

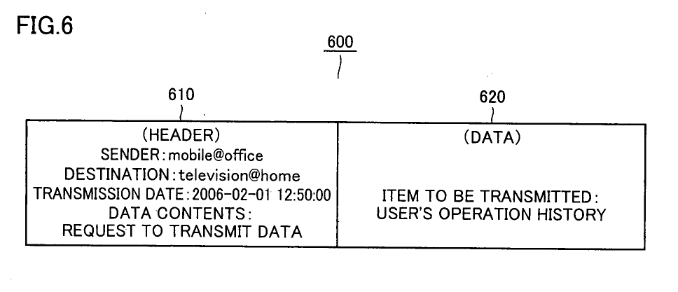

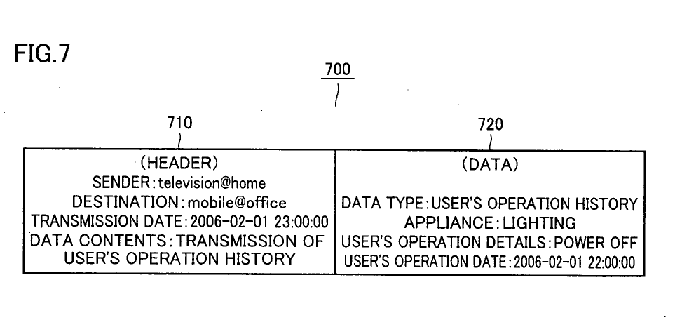

Referring to FIGS. 6 and 7, communication between television 100 and another information communication apparatus is described. FIG. 6 conceptually shows a structure of a packet 600 transmitted from mobile phone 180 to television 100.

Packet 600 includes a header 610 and data 620. Header 610 includes data for identifying the transmitter of packet 600 (address on the network allocated in advance to mobile phone 180 for example), data for identifying the destination of packet 600 (address on the network of television 100 for example), date at which packet 600 is transmitted and attribute data showing contents of packet 600. Data 620 includes a specific data item associated with the attribute included in header 610. Data 620 includes, for example, data showing that an item to be transmitted is “user's operation history.”

Packet 600 is generated by a CPU (not shown) of mobile phone 180. The CPU generates packet 600 based on user's operation on mobile phone 180. The user of mobile phone 180 performs a predetermined connection procedure to establish connection between mobile phone 180 and the Internet 150 and thereby access television 100. After the access is implemented, mobile phone 180 transmits packet 600 to television 100.

FIG. 7 conceptually shows a structure of a packet 700 transmitted from television 100 to mobile phone 180. Packet 700 includes a header 710 and data 720.

Header 710 includes data for identifying the transmitter of packet 700 (address on the network of television 100 for example), data for identifying the destination of packet 700 (address on the network of mobile phone 180 for example), date at which packet 700 is transmitted and an attribute showing contents of packet 700. Data 720 has, as specific data items, items associated with the attribute included in header 710. Specifically, data 720 includes data showing that the data type is “user's operation history,” data showing an appliance (lighting for example) that is operated, data showing details of the user's operation (power off for example) and data showing the date at which the user's operation is performed.

Packet 700 is generated by CPU 210 of television 100. Specifically, CPU 210 generates packet 700 by generation unit 320. When packet 700 is generated, CPU 210 transmits the packet via communication IF 270 to the Internet 150 by communication control unit 330. In the case where communication between television 100 and mobile phone 180 is established, packet 700 is received by mobile phone 180.

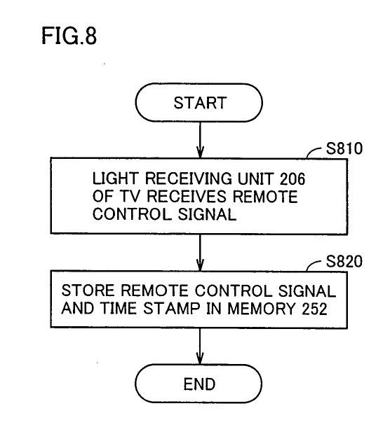

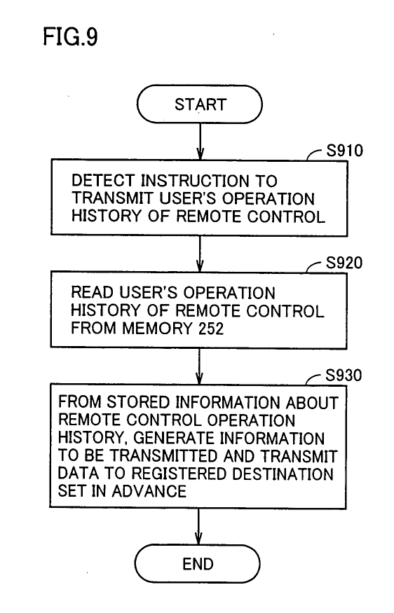

Referring to FIGS. 8 and 9, a control structure of television 100 is described. FIG. 8 is a flowchart showing a process procedure performed when television 100 receives an infrared signal from remote control 130.

In step S810, light receiving unit 206 of television 100 receives the infrared signal transmitted from remote control 130. Light receiving unit 206 converts the signal into an electrical signal to transmit the electrical signal to CPU 210.

In step S820, CPU 210 associates the signal transmitted from light receiving unit 206 with time data (time stamp) obtained from the internal clock (not shown) to store them in memory 252 (FIG. 4).

The above-described process is essentially performed when television 100 displays an image and performed as well when no image is displayed. In other words, as long as television 100 is supplied with electric power, the name of an appliance and details of user's operation that are included in the infrared signal received from light receiving unit 206 are successively stored in memory 252.

FIG. 9 is a flowchart showing a process procedure performed by television 100 for transmitting data stored in memory 252. This process is performed when CPU 210 detects arrival of predetermined time based on time data from the internal clock, or when a request to transmit data is accepted via communication IF 270.

In step 910, CPU 210 detects an instruction to transmit a history of user's operation on remote control 130. The detection is made, for example, at a predetermined time or based on a request to transmit the history sent from mobile phone 180 or PC 170. In step 920, CPU 210 reads the user's operation history stored in memory 252 and temporarily stores it in memory 212.

In step S930, CPU 210 uses the user's operation history and the destination stored in memory 212 to generate transmission information. The destination stored in memory 212 may be data registered in advance for television 100 (electronic mail address for example) or may be an address showing the transmitter of the mail included in the electronic mail received via communication IF 270. CPU 210 generates the transmission information and then refers to data stored in memory 212 to transmit the information as history data to the outside via communication IF 270.

Accordingly, in the case where communication has been established between television 100 and another information communication apparatus (mobile phone 180, PC 170 for example), the data is transmitted to this information communication apparatus. The user of mobile phone 180 or PC 170 can read the data in the form of an electronic mail to know the status of user's operation on the appliance held by television 100.

Thus, another user present on the outside of house 10 is also informed of the data as shown in FIG. 7. Therefore, the state of a family member in a remote place for example can be known easily. In the example shown in FIG. 7, the user's operation history at the specific timing is included as data in data 720 included in packet 700. The data thus included corresponds to the latest history when a request to transmit the history is received by television 100 for example. However, the history at another time may be transmitted. For example, at every other hour on every day, the latest history at that time may be transmitted.

In this way, television 100 in the present embodiment acquires, from a signal transmitted in response to user's operation on the remote control, information about the user's operation and transmits a user's operation history via a communication line. Thus, power ON/OFF and change of the channel for example of television 100 are transmitted to any person other than the operator, so that the family of the operator and those concerned can know the conditions of the operator, which helps confirmation as to whether the operator is safe and well.

### Second Embodiment

A television according to the present embodiment differs from that of the preceding embodiment in that the former television has the capability of selectively structuring a user's operation history to be transmitted, according to a transmitter of a request to transmit the history of the user's operation on a remote control. The television of the present embodiment and television 100 illustrated in the first embodiment are identical in hardware configuration and functions thereof Therefore, the detailed description thereof is not repeated here.

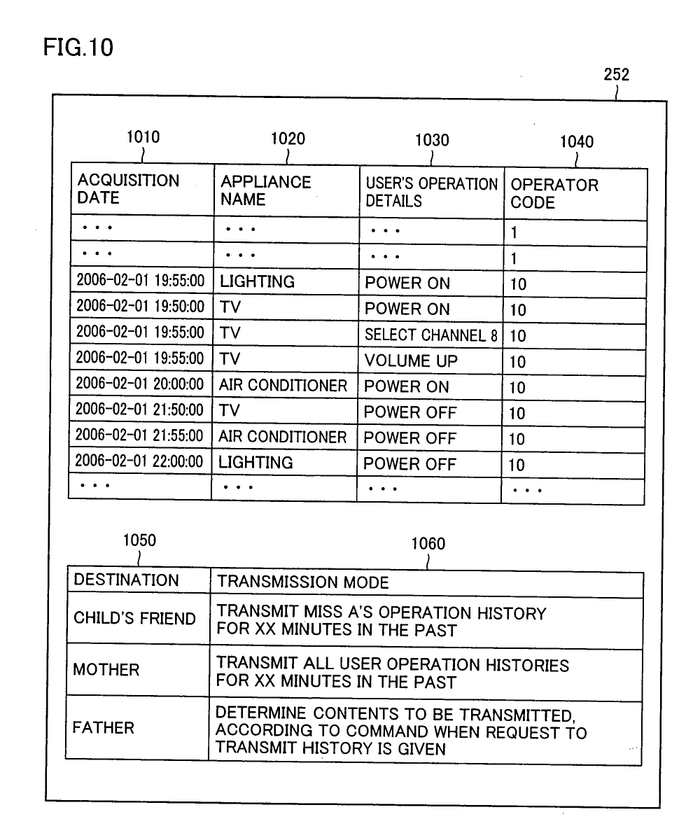

Referring to FIG. 10, a data structure of television 100 in the present embodiment is described. FIG. 10 conceptually shows a manner of storage of data in memory 252. Memory 252 includes areas 1010 to 1060 for storing data.

Data showing the date at which a user's operation history of remote control 130 or remote control 132 is acquired is stored in area 1010. Data for identifying an appliance controlled by the user's operation is stored in area 1020. Data showing details of the user's operation is stored in area 1030. Data showing the user performing the operation is stored in the form of an operator code for example in area 1040. A destination registered in advance for selectively transmitting the user's operation history is stored in area 1050. What is transmitted in the form of a history that is associated with the destination is stored in area 1060.

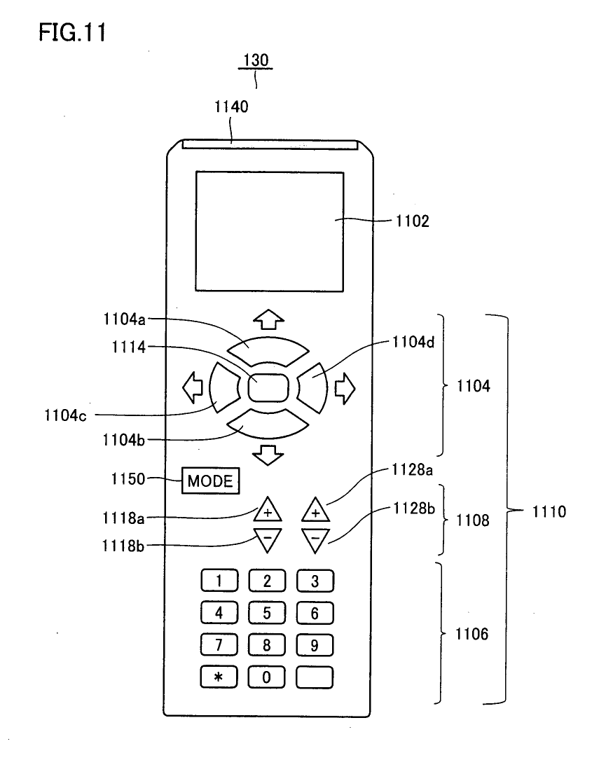

Referring to FIG. 11, a description is given of the remote control capable of transmitting data (in area 1040) for identifying an operator of the remote control. FIG. 11 shows a configuration of remote control 130 having the capability as described above. Remote control 130 includes a light-emitting unit 1140 for transmitting a control signal to an appliance to be controlled, a display 802 displaying character information and a user's operation unit 1110 accepting input of an externally given instruction to output a signal according to the input. User's operation unit 1110 is implemented for example with buttons or a dial. User's operation unit 1110 includes cursor buttons 1104a, 1104b, 1104c, 1104d indicating upward, downward, rightward and leftward movements of a cursor shown on display 1102, an enter button 1114 accepting input of an instruction for determining data that is input by the user of remote control 130, an up-and-down button 1108 increasing or decreasing the value of control data included in a control signal to be output, and numerical buttons 1106. Up-and-down button 1108 includes buttons 1118a, 1128a accepting an instruction to increase the value of control data and buttons 1118b, 1128b accepting input of an instruction to decrease the value of control data.

Remote control 130 further includes a button 1150 accepting an instruction to change the operational mode of remote control 130. The user of remote control 130 may use button 1150 and numerical buttons 1106 in combination and at the same timing so that a control signal is transmitted thereafter as a result of operation by the user associated in advance with a number specified by numerical buttons 1106.

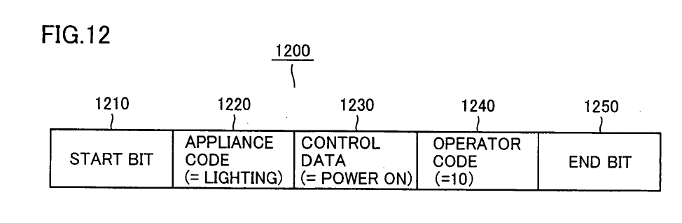

Referring now to FIG. 12, an infrared signal 1200 transmitted by remote control 130 is described. Infrared signal 1200 includes a start bit 1210, an appliance code 1220, control data 1230, an operator code 1240 and an end bit 1250.

Start bit 1210 indicates the leading end of infrared signal 1200. Appliance code 1220 corresponds to the data for identifying the appliance to be controlled by remote control 130. For example, in the example shown in FIG. 12, infrared signal 1200 is identified as the one controlling lighting 110. Control data 1230 corresponds to a specific control item associated with the appliance identified by appliance code 1220. Operator code 1240 shows the user operating remote control 130 when infrared signal 1200 is transmitted. End bit 1250 represents the end of infrared signal 1200. Specifically, infrared signal 1200 is identified as a control signal transmitted by operator “10” for turning on lighting 110.

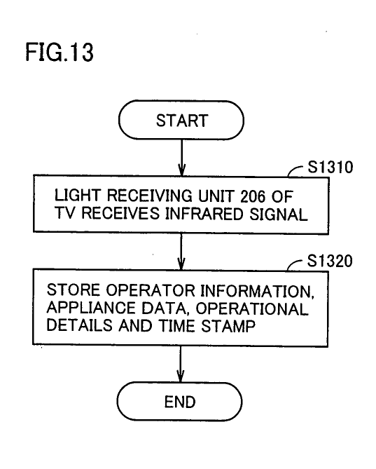

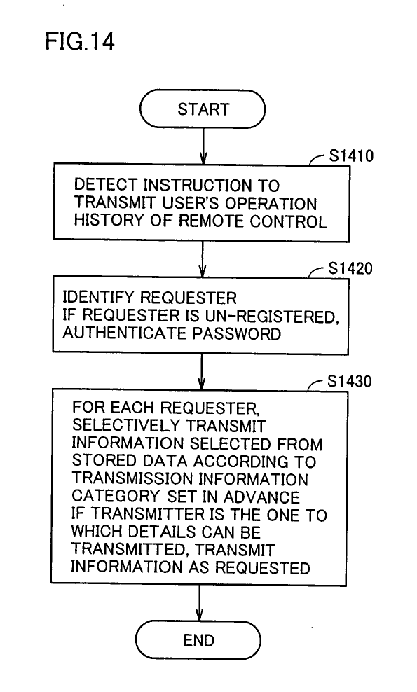

Referring to FIGS. 13 and 14, a control structure of television 100 in the present embodiment is described. FIG. 13 is a flowchart showing a process procedure performed when television 100 receives an infrared signal from remote control 130.

In step S1310, light receiving unit 206 of television 100 receives the infrared signal transmitted from remote control 130. Light receiving unit 206 converts the signal into an electrical signal to transmit the signal to CPU 210. CPU 210 extracts, from the signal transmitted from light receiving unit 206, data identifying the operator, appliance code and details of the user's operation. CPU 210 further stores in memory 252 time information (time stamp) transmitted from an internal clock (not shown) in association with the extracted data (FIG. 10).

FIG. 14 is a flowchart showing a process procedure performed for transmitting an operator's operation history from television 100 to a specific user. The process is performed when, for example, a request to transmit is received from an external user (user of mobile phone 180 or user of PC 170), or when CPU 210 detects the arrival of a preset time.

In step S1410, CPU 210 detects an instruction to transmit a user's operation history of remote control 130. In step S1420, CPU 210 identifies the transmitter of the instruction to transmit (the requester of the user's operation history). Specifically, an address included in the instruction to transmit and an address stored in memory 252 are compared with each other to determine whether or not the instruction to transmit is an instruction from a user registered in advance. When CPU 210 determines that the requester giving the instruction to transmit is an operator who is not registered, CPU 210 returns an instruction to enter a password, and starts access with ensured security. In the case where the requester is successfully identified in step S 1420, transmission is thereafter carried out. In contrast, if the identification fails, the user's operation history according to the instruction to transmit is not transmitted. To the access using a password, the well known art is applied. For example, a password may be stored in advance in television 100 and the password and an input password may be compared with each other for authentication.

In step S1430, according to each requester of the user's operation history and based on the operational information category (in area 1060) set in advance in memory 252, CPU 210 selectively obtains the stored user's operation history. Specifically, CPU 210 identifies a transmission mode (in area 1060) associated with the requester identified by the data in area 1050. CPU 210 refers to transmission mode 1060 to identify a data item to be transmitted. Using the identified item as a key, CPU 210 searches areas 1010 to 1040 to extract the specific data item. CPU 210 temporarily stores the extracted data item in memory 212 and uses the data and the destination identified in advance to generate a packet to be transmitted. This packet has its structure similar to that of packet 700 for example shown in FIG. 7. In the present embodiment, regarding the item included in data 720, a plurality of items may be stored depending on the transmission mode.

In the manner as described above, television 100 in the present embodiment can transmit information about user's operation of the remote control for each of users registered in advance. Further, contents of information to be transmitted can be changed depending on the user. Thus, for each specific user, the behavior of the user can be ascertained. Therefore, the user can be watched accurately by a remote family member for example.

### Third Embodiment

A third embodiment of the present invention is described hereinafter. A television according to the present embodiment differs from respective televisions of the above-described embodiments in that the television of the present embodiment has the capability of displaying received data in response to transmission of a user's operation history.

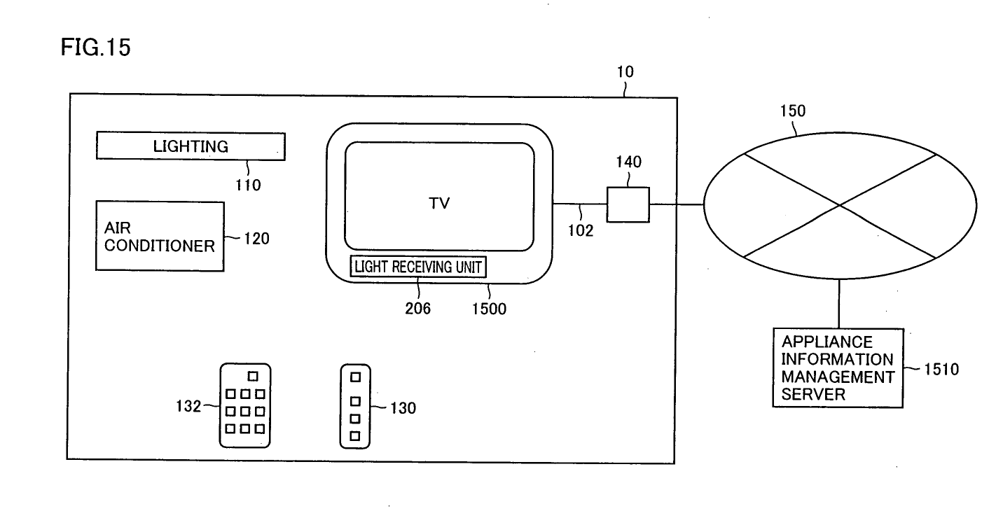

FIG. 15 shows a network configuration using television 1500 of the present embodiment. Referring to FIG. 15, television 1500 is connected via cable 102 to gateway 140. Gateway 140 is connected to the Internet 150. To the Internet 150, an appliance information management server 1510 is connected.

CPU 210 implementing television 1500 obtains information for identifying the appliance via communication IF 270. Specifically, CPU 210 generates a request to transmit information about the appliance and instructs communication IF 270 to transmit the transmission request to the server.

Other elements are identical to those shown in FIG. 1. Thus, the detailed description thereof is not repeated here.

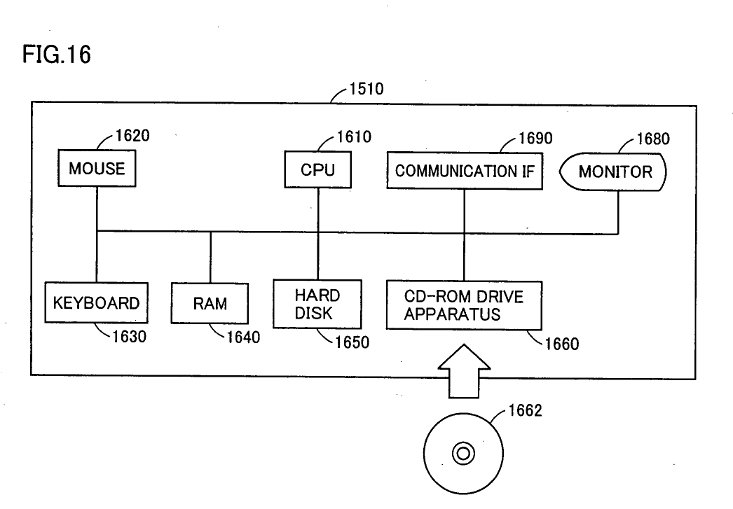

Referring to FIG. 16, appliance information management server 1510 is described. Appliance information management server 1510 includes, as main components, a CPU 1610, a mouse 1620 and a keyboard 1630 for accepting input of an instruction by a manager of the appliance information management server, a RAM (Random Access Memory) 1640 temporarily storing input data or data generated through a process executed according to a program, a hard disk 1650 on which data can be stored in nonvolatile manner, a CD-ROM (Compact Disk—Read Only Memory) drive apparatus 1660, a monitor 1680, and a communication IF 1690 that are connected to each other by a data bus. On CD-ROM drive apparatus 1660, a CD-ROM 1662 can be mounted. Communication IF 1690 is connected to the Internet 150.

A process in a computer system serving as appliance information management server 1510 is implemented by a program executed by CPU 1610 and each hardware operating according to execution of the program. Such a program may be stored in advance in RAM 1640 or hard disk 1650 or may be stored on such recording media as CD-ROM 1662 and distributed in the form of a program product. Data stored on a data recording medium is read by CD-ROM drive apparatus 1660 or another reading apparatus to be stored temporarily on hard disk 1650.

The program is read from RAM 1640 or hard disk 1650 and executed by CPU 1610. Each hardware item shown in FIG. 16 is a commonly used one. Therefore, the most essential element for implementing appliance information management server 1510 is the program stored in RAM 1640, hard disk 1650, CD-ROM 1662 or other data recording medium. The operation of the above-described hardware items each would be easily understandable by those skilled in the art. Therefore, a detailed description thereof is not given.

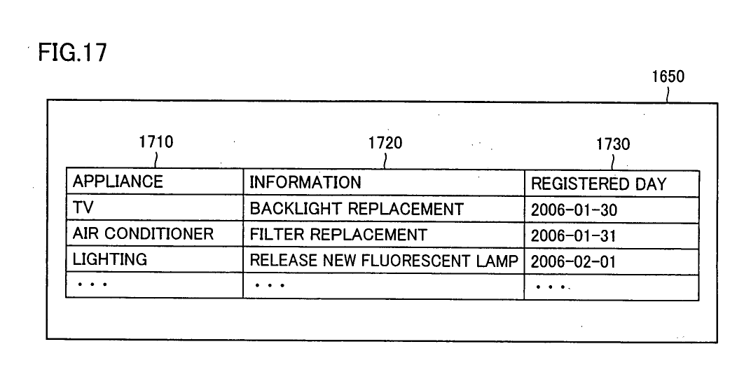

Referring to FIG. 17, a data structure of appliance information management server 1510 is described. Hard disk 1650 includes areas 1710 to 1730 for storing data. Data for identifying an appliance to which information is to be provided is stored in area 1710. Specific contents of the information to be provided for the appliance are stored in area 1720. Data showing the registered day on which the information is stored on hard disk 1650 is stored in area 1730. The data items stored respectively in areas 1710 to 1730 are associated with each other. Therefore, any of the areas storing a certain data item may be designated to determine other information items associated with the information item stored in the designated area.

CPU 1610 of appliance information management server 1510 refers to data stored on hard disk 1650 and uses the data to generate a packet to be transmitted to an appliance that requests supply of information. Generating the packet, CPU 1610 transmits the packet via communication IF 1690 to the Internet 150. The packet is transmitted to a destination designated based on an address contained therein.

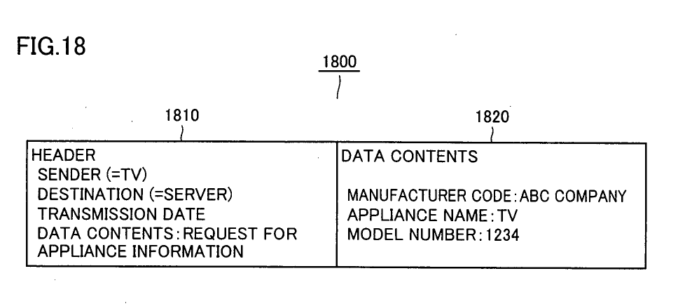

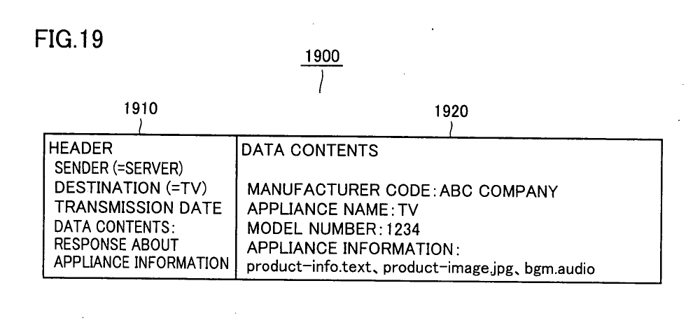

Referring to FIGS. 18 and 19, communication between television 1500 and appliance information management server 1510 in the present embodiment is described. FIG. 18 conceptually shows a structure of a packet 1800 transmitted from television 1500 to appliance information management server 1510. Packet 1800 includes a header 1810 and data contents 1820. Header 1810 includes data for identifying the transmitter (namely television 1500) of packet 1800, data for identifying the destination (appliance information management server 1510) to which packet 1800 is to be transmitted, the date at which packet 1800 is transmitted, and data showing an attribute (data contents) of packet 1800. The data contents refer to data showing any appliance whose information is requested by means of packet 1800. Data contents 1820 include specific items associated respectively with data contents included in header 1810. Specifically, data contents 1820 include the manufacturer code (ABC company), the name of the appliance (television) and the model number (1234) of the appliance.

FIG. 19 conceptually shows a structure of a packet 1900 transmitted from appliance information management server 1510 to television 1500. Packet 1900 includes a header 1910 and data contents 1920.

Header 1910 includes data for identifying the transmitter of packet 1900 (address for identifying the position of appliance information management server 1510 on the Internet 1500), data for identifying the destination of packet 1900 (address of television 1500 for example on the network), the date at which packet 1900 is transmitted and attribute information showing contents of data transmitted by packet 1900 (“appliance information response” for example).

Data contents 1920 include a manufacturer code for identifying the manufacturer of an appliance with which the information is associated, the appliance name for identifying the appliance, the model number for identifying the type of the appliance, and specific appliance information. Regarding the example of packet 1900, information about the appliance “television” to be transmitted includes text information (product-info.text), image (product-image.jpg) and audio data (bgm.audio).

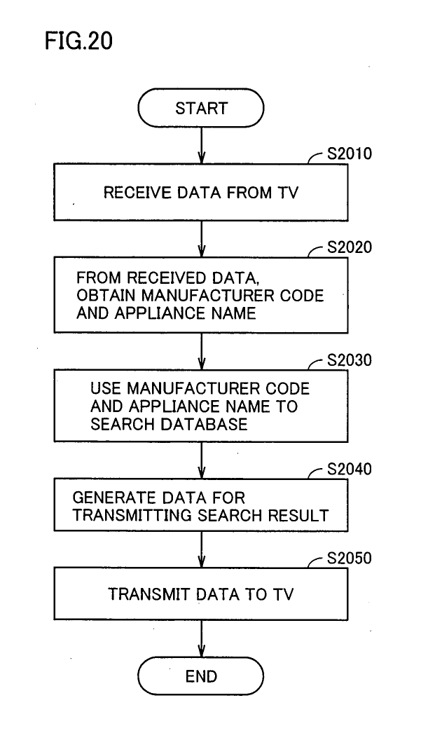

Referring next to FIG. 20, a control structure of appliance information management server 1510 is described. FIG. 20 is a flowchart showing a process procedure performed by CPU 1610 of appliance information management server 1510.

In step S2010, CPU 1610 detects, based on an input signal, data (packet 1800) showing a request to transmit appliance information is received from television 1500 via the Internet 150. In step S2020, CPU 1610 obtains, from packet 1800, such information items as manufacturer code, appliance name and model number (data contents 1820), and write the information in an area temporarily reserved in RAM 1640.

In step S2030, CPU 1610 refers to the data written in RAM 1640 to search database included in hard disk 1650 (FIG. 17). In step S2040, based on the result of the search of table 1700, CPU 1610 generates data in RAM 1640 for transmitting the appliance information. Then, using the transmitter (header 1810) included in packet 1800 received in step S2010, CPU 1610 generates packet 1900 for transmitting the result of the search. In step S2050, CPU 1610 transmits packet 1900 as generated to the Internet 150 via communication IF 1690. Accordingly, in the case where television 1500 is connected to the Internet 150, packet 1900 is received by television 1500.

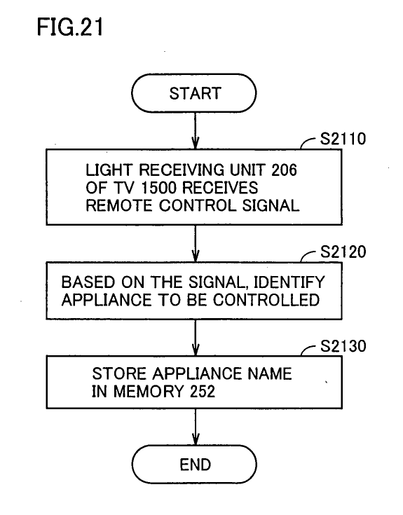

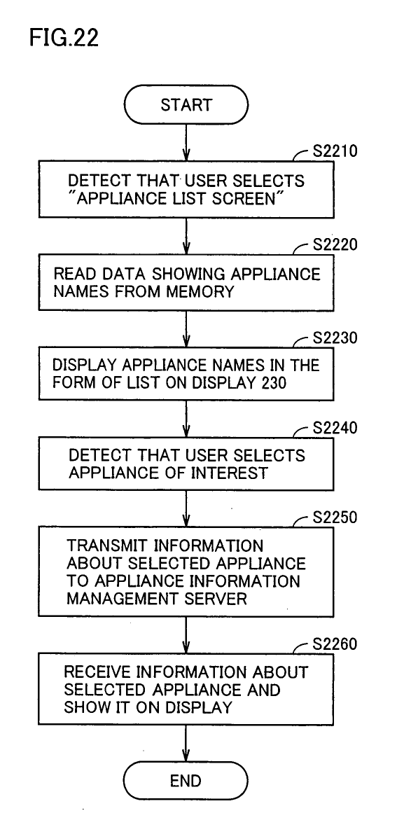

Referring next to FIGS. 21 and 22, a control structure of television 1500 in the present embodiment is described. FIG. 21 is a flowchart showing a process procedure performed when television 1500 receives an infrared signal from remote control 130.

In step S2110, CPU 210 detects that light receiving unit 206 of television 1500 receives a remote control signal. In step S2120, based on the signal, CPU 210 identifies an appliance to be controlled by remote control 130. In step S2130, CPU 210 stores the name of the identified appliance in an area reserved in memory 250.

FIG. 22 is a flowchart showing a process procedure implemented when a user makes a predetermined connection for obtaining information about an appliance.

In step S2210, CPU 210 of television 1500 detects that the user selects “appliance list screen.” In step S2220, CPU 210 reads from memory 252 data showing the names of appliances registered in advance. In step S2230, CPU 210 generates a signal to be displayed, based on the read data. Based on the signal, a list of appliance names is shown on display 230.

In step S2240, CPU 210 detects that the user selects an appliance about which the user wants to have information, based on an infrared signal received by light receiving unit 206. In step S2250, CPU 210 generates data for requesting information about the appliance and transmits the data via communication IF 270 to appliance information management server 1510. Appliance information management server 1510 receiving the data performs the above-described process (FIG. 20).

In step S2260, CPU 210 receives information about the appliance of interest that is transmitted via communication IF 270 from appliance information management server 1510. Based on the information, CPU 210 instructs display 230 to show characters. In the case where the received information includes image data or audio data, a relevant image is shown on display 230 based on the image data and sounds are output based on the audio data respectively from speakers 240a, 240b.

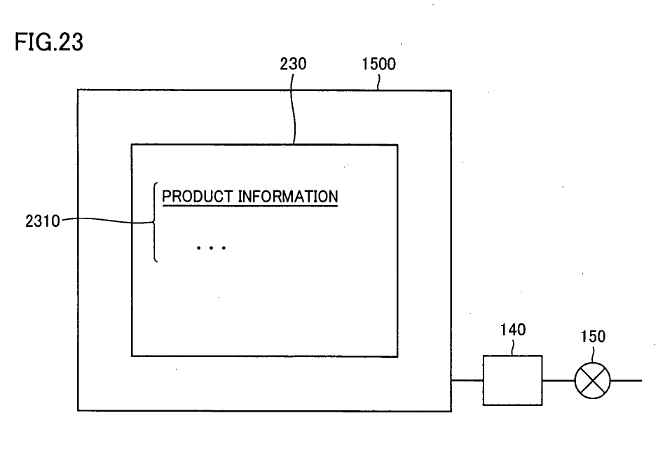

FIG. 23 shows television 1500 displaying information about an appliance. Television 1500 displays, on display 230, relevant information about an appliance based on received information. Specifically, in the form of character information 2310 for example, product information and other information items concerning the appliance selected by the user are displayed.

As heretofore described, television 1500 in the present embodiment allows a user to obtain product information concerning a specific appliance, information about relevant products and other information items.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A television receiving apparatus comprising:
a display unit displaying an image;
a light receiving unit receiving an infrared signal for controlling operation of a plurality of appliances each, said infrared signal including appliance data for identifying said appliances each and control data for instructing to change a predetermined operation of said appliances each;
a storage unit storing said control data;
a control unit controlling, when said appliance data is data for identifying said television receiving apparatus, operation of said television receiving apparatus based on said control data;
a generation unit generating, based on said data for instructing to change the operation, data showing that said operation is changed, as user's operation data,
said storage unit further storing identification data for identifying a communication apparatus that is a destination of said user's operation data; and
a transmission unit transmitting said user's operation data through a communication line based on said identification data.

2. A television receiving apparatus comprising:
a display unit displaying an image;
a light receiving unit receiving an infrared signal used for controlling operation of a plurality of appliances each, said infrared signal including appliance data for identifying said appliances each and data for instructing to perform a predetermined operation of said appliances each;
a storage unit storing said control data;
a control unit controlling, when said appliance data is data for identifying said television receiving apparatus, operation of said television receiving apparatus based on said control data;
a generation unit generating, based on said control data associated with said appliance data, user's operation data showing details of operation of the appliance identified by said appliance data; and
an output unit outputting said user's operation data.

3. The television receiving apparatus according to claim 2, wherein
said control data includes data for instructing to change operation of said appliances each, and
said generation unit generates, based on said data for instructing to change the operation, data as said user's operation data showing that said operation is changed.

4. The television receiving apparatus according to claim 3, wherein
said appliance is an air conditioner,
said data for instructing to change the operation includes data for instructing to power on or off said air conditioner, and
said generation unit generates, based on said data for instructing to power on or off said air conditioner, data as said user's operation data showing that the operation of said air conditioner is changed.

5. The television receiving apparatus according to claim 3, wherein
said appliance is a lighting,
said data for instructing to change the operation includes data for instructing to turn on or off said lighting, and
said generation unit generates, based on said data for instructing to turn on or off said lighting, data as said user's operation data showing that said lighting is turned on or off.

6. The television receiving apparatus according to claim 2, wherein
said output unit includes a transmission unit transmitting said user's operation data via a communication line.

7. The television receiving apparatus according to claim 6, wherein
said storage unit further stores identification data for identifying a communication apparatus that is a destination of said user's operation data, and
said transmission unit transmits said user's operation data to said communication apparatus based on said identification data.

8. The television receiving apparatus according to claim 6, further comprising a clock unit detecting time, wherein
said transmission unit transmits said user's operation data at a predetermined time interval.

9. The television receiving apparatus according to claim 6, further comprising a clock unit detecting time, wherein
said transmission unit transmits said user's operation data at predetermined time.

10. The television receiving apparatus according to claim 6, further comprising a reception unit connected to said communication line and receiving a signal including an instruction for requesting transmission of said user's operation data, wherein
said transmission unit transmits said user's operation data based on said instruction.

11. The television receiving apparatus according to claim 10, wherein
said storage unit successively stores said control data, and
said generation unit generates, based on said instruction for requesting transmission, said user's operation data using said control data that is stored lastly at the time when said signal is received.

12. The television receiving apparatus according to claim 6, further comprising:
a light emission unit transmitting a control signal in the form of a light signal for controlling operation of an appliance; and
a reception unit receiving, via said communication line, a signal including an instruction to transmit said control signal, wherein
said control unit instructs said light emission unit to transmit said control signal based on said instruction.

13. The television receiving apparatus according to claim 6, wherein
said storage unit further stores access information for accessing a server apparatus providing information about an appliance,
said control unit includes:
an acquisition unit acquiring information for identifying said appliance based on said infrared signal;
a request generation unit generating a request for transmission of information concerning said appliance; and
a transmission control unit instructing said transmission unit to transmit said request for transmission to said server apparatus based on said access information,
said television receiving apparatus further comprises a reception unit receiving said information concerning said appliance from said server apparatus via said communication line, and
said display unit displays an image based on said information concerning said appliance.
